(19) United States
(12) Patent Application Publication
(10) Pub. No.: US 2025/0171232 A1
(43) Pub. Date: May 29, 2025

(54) ARRANGEMENT CONTROL SYSTEM, ARRANGEMENT CONTROL APPARATUS, AND ARRANGEMENT CONTROL METHOD

(71) Applicant: NEC Corporation, Minato-ku, Tokyo (JP)

(72) Inventors: Rieko UENO, Tokyo (JP); Hiromi MUTO, Tokyo (JP); Hidekazu NAGAOKA, Tokyo (JP)

(73) Assignee: NEC Corporation, Minato-ku, Tokyo (JP)

(21) Appl. No.: 18/834,301

(22) PCT Filed: Feb. 4, 2022
(86) PCT No.: PCT/JP2022/004543

§ 371 Date: Jul. 30, 2024

(51) Int. Cl. B65G 1/137

(52) U.S. Cl. CPC B65G 1/137; B65G 2203/042

(57) ABSTRACT

In an arrangement control system, an acquisition unit acquires upper limit information indicating an arrangement space in a candidate arrangement location of a target object and target object information including size information indicating a size of the target object. In addition, the acquisition unit acquires information regarding the occupied space of the arrangement object arranged in the candidate arrangement location detected by a sensing unit. A determination unit determines whether a target object can be arranged in the candidate arrangement location based on the upper limit information, the target object information, and the information regarding the occupied space of the arrangement object acquired by the acquisition unit.

### TECHNICAL FIELD

The present disclosure relates to an arrangement control system, an arrangement control apparatus, and an arrangement control method.

### BACKGROUND ART

An apparatus for recommending a location for arranging an article in a store of articles has been proposed (for example, Patent Literature 1). In the technique disclosed in Patent Literature 1, information regarding a location and information regarding an arrangement target object are stored in advance, and the location is recommended using the stored information.

### CITATION LIST

### Patent Literature

Patent Literature 1: Japanese Unexamined Patent Application Publication No. 2021-167249

### SUMMARY OF INVENTION

### Technical Problem

In the technique disclosed in Patent Literature 1, a location where a target object can be arranged is specified based on information regarding a location stored in advance. However, for example, in a warehouse or the like, the situation of the location is likely to change, and there is a possibility that the stored information regarding the location is out of date and may not reflect the current situation of the location. As a result, in the technique disclosed in Patent Literature 1, it is not possible to accurately determine whether the target object can be arranged in the candidate arrangement location, and the transport efficiency may be reduced.

An object of the present disclosure is to provide an arrangement control system, an arrangement control apparatus, and an arrangement control method capable of improving the efficiency of arranging a target object at an arrangement location.

### Solution to Problem

An arrangement control system according to a first aspect includes:
an acquisition means for acquiring upper limit information indicating an arrangement space in a candidate arrangement location of a target object, target object information including size information indicating a size of the target object, and information regarding an occupied space of an arrangement object arranged in the candidate arrangement location detected by a sensing means; and
a determination means for outputting a determination result obtained by determining whether the target object can be arranged in the candidate arrangement location based on the upper limit information, the target object information, and the information regarding the occupied space of the arrangement object.

An arrangement control apparatus according to a second aspect includes:
an acquisition means for acquiring upper limit information indicating an arrangement space in a candidate arrangement location of a target object, target object information including size information indicating a size of the target object, and information regarding an occupied space of an arrangement object arranged in the candidate arrangement location detected by a sensing means; and
a determination means for outputting a determination result obtained by determining whether the target object can be arranged in the candidate arrangement location based on the upper limit information, the target object information, and the information regarding the occupied space of the arrangement object.

An arrangement control method according to a third aspect includes:
acquiring upper limit information indicating an arrangement space in a candidate arrangement location of a target object, target object information including size information indicating a size of the target object, and information regarding an occupied space of an arrangement object arranged in the candidate arrangement location detected by a sensing means; and
outputting a determination result obtained by determining whether the target object can be arranged in the candidate arrangement location based on the upper limit information, the target object information, and the information regarding the occupied space of the arrangement object.

### Advantageous Effects of Invention

According to the present disclosure, it is possible to provide an arrangement control system, an arrangement control apparatus, and an arrangement control method capable of improving the efficiency of arranging a target object at an arrangement location.

### BRIEF DESCRIPTION OF DRAWINGS

FIG. 1 is a diagram illustrating an example of an arrangement control system according to a first example embodiment.

FIG. 2 is a diagram illustrating an example of an arrangement control apparatus according to the first example embodiment.

FIG. 3 is a flowchart illustrating an example of the processing operation of the arrangement control system and the arrangement control apparatus according to the first example embodiment.

FIG. 4 is a diagram for explaining an example of an arrangement control system in the first example embodiment.

FIG. 5 is a diagram illustrating an example of an arrangement control system according to a second example embodiment.

FIG. 6 is a diagram illustrating an example of an arrangement control apparatus according to the second example embodiment.

FIG. 7 is a flowchart illustrating an example of a processing operation of an arrangement control system and an arrangement control apparatus according to the second example embodiment.

FIG. 8 is a diagram illustrating an example of an arrangement control system according to a third example embodiment.

FIG. 9 is a diagram illustrating an example of map information.

FIG. 10 is a diagram illustrating an example of an arrangement control apparatus according to the third example embodiment.

FIG. 11 is a flowchart illustrating an example of the processing operation of the arrangement control system and the arrangement control apparatus according to the third example embodiment.

FIG. 12 is a diagram illustrating an example of an arrangement control system according to a fourth example embodiment.

FIG. 13 is a schematic view of the arrangement object as viewed from above.

FIG. 14 is a view illustrating an example of an upper surface of an arrangement object.

FIG. 15 is a view illustrating another example of the upper surface of the arrangement object.

FIG. 16 is a view for explaining a deviation between a first object and a second object constituting an arrangement object.

FIG. 17 is a diagram illustrating an example of an arrangement control apparatus according to the fourth example embodiment.

FIG. 18 is a flowchart illustrating an example of the processing operation of the arrangement control system and the arrangement control apparatus according to the fourth example embodiment.

FIG. 19 is a diagram illustrating a hardware configuration example of the arrangement control apparatus.

### EXAMPLE EMBODIMENT

Hereinafter, example embodiments will be described with reference to the drawings. Note that the following description and drawings are omitted and simplified as appropriate for clarity of description. Furthermore, in each of the drawings described below, the same element is denoted by the same reference numeral, and redundant description will be omitted as necessary. In addition, specific numerical values and the like shown below are only examples to facilitate understanding of the present disclosure, and are not limited thereto.

### First Example Embodiment

### Arrangement Control System

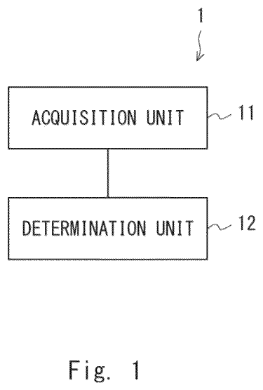

FIG. 1 is a diagram illustrating an example of an arrangement control system according to a first example embodiment. In FIG. 1, an arrangement control system 1 includes an acquisition unit 11 and a determination unit 12. Note that, in the arrangement control system 1, the acquisition unit 11 and the determination unit 12 may be provided in the same apparatus. Furthermore, the acquisition unit 11 and the determination unit 12 may be provided independently of each other, and for example, may be provided on different apparatuses or on a cloud. That is, the arrangement positions of the acquisition unit 11 and the determination unit 12 are not particularly limited.

The acquisition unit 11 acquires “upper limit information indicating an arrangement space” in a “candidate arrangement location” of a “target object”.

Here, the “target object” means an object to be transported to an arrangement location by a transport apparatus (not illustrated) and arranged at the arrangement location. For example, when the use case of the arrangement control system 1 is a distribution warehouse, the “target object” may be a luggage and a pallet on which the luggage is placed. For example, in a case where the use case of the arrangement control system 1 is a factory or a plant, the “target object” may be a product or a component, and a box or a container in which these are stored. Some transport apparatuses (not illustrated) operate by human operation, and some autonomously operate. In addition, some of the transport apparatuses operate by combining an autonomous operation and an operation of boarding operation or remote operation by a person. For example, specific examples of the transport apparatuses include a forklift and an AGV (Automatic Guided Vehicle), which is also called an unmanned transport vehicle or an unmanned transport robot.

In addition, the “candidate arrangement location” means a candidate for an arrangement location that has not yet been determined as an arrangement location of a target object. For example, when the use case of the arrangement control system 1 is a distribution warehouse, the “candidate arrangement location” may be a floor surface or a shelf surface of a certain zone in the distribution warehouse, or may be on an arrangement object already arranged on the floor surface or the shelf surface. Alternatively, for example, when the use case of the arrangement control system 1 is a distribution warehouse, the “candidate arrangement location” may be a loading platform of a truck that transports a target object.

In addition, the “arrangement space” means a space in which a target object can be arranged at an arrangement location. The “arrangement space” may be, for example, a space extending above a floor surface or a shelf surface, or may be a space of a cargo bed of a truck.

Furthermore, the “upper limit information indicating the arrangement space” is information indicating a spread of the arrangement space, and may be, for example, an upper limit value regarding a height, a width, and a depth of the arrangement space, and an arbitrary combination thereof. For example, when the use case of the arrangement control system 1 is a distribution warehouse, the “upper limit information indicating the arrangement space” may be a height from a floor surface to a ceiling of the distribution warehouse, or may be an allowable height that allows upper surfaces of target objects stacked in the distribution warehouse to reach. Alternatively, the “upper limit information indicating the arrangement space” may be, for example, a height limit value in consideration of safety. Alternatively, when the type of the object to be placed in the candidate arrangement location is determined, the “upper limit information indicating the arrangement space” may be a height limit value, a width limit value, a depth limit value according to the type of the object, or an arbitrary combination thereof. In addition, in a case where the arrangement object already exists on the far side, the left side, and the right side of the arrangement location, the “upper limit information indicating the arrangement space” may be a width upper limit value indicating a width between the left side and the right side of the arrangement location (for example, a distance between the left and right arrangement objects), a depth upper limit value indicating a depth of the arrangement location (for example, the distance from the line where the front faces of the left and right arrangement objects are aligned to the arrangement object placed at the back of the arrangement location), and a combination thereof. Furthermore, for example, the “upper limit information indicating the arrangement space” may be a width upper limit value indicating a length in the width direction of a range in which the centers of gravity of the “arrangement object” and the “target object” are balanced in a case where the target object is arranged on the “arrangement object” described later while protruding from the upper surface of the “arrangement object”, a depth upper limit value indicating a length in the depth direction of the range, and a combination thereof.

Furthermore, the acquisition unit 11 acquires “target object information” regarding the target object.

The “target object information” may include “size information” indicating the size of the target object. The “size information” is information indicating the spread of the space occupied by the target object, and may be, for example, the height, width, and depth of the target object, and any combination thereof.

Note that the information included in the “target object information” is not limited to the “size information”, and the “target object information” may include information regarding the weight of the target object. Furthermore, for example, in a case where the target object is a delivery object, the “target object information” may include delivery destination information (customer information or the like). Based on the delivery destination information, the loading platform of the truck corresponding to the delivery destination indicated by the delivery destination information may be selected as the “candidate arrangement location”.

The “target object information” may include an “arrangement condition”. The “arrangement condition” means an additional condition to be satisfied when the target object is arranged in the candidate arrangement location. For example, the “arrangement condition” may include a condition “stacking prohibited” in a case where the target object is a fragile object. Furthermore, the “arrangement condition” may include a condition regarding a height at which arrangement of a target object is allowed, a condition regarding the weight of an object allowed to be placed on the target object, and the like. As an example of the condition regarding the height at which the arrangement of the target object is allowed, for example, a condition that “the object is not placed at a position higher than 10 meters” can be mentioned. In addition, as an example of the condition regarding the weight of an object allowed to be placed on the target object, for example, a condition of “not loading luggage of 100 kilograms or more on the target object” can be mentioned. Furthermore, for example, the “arrangement condition” may include a condition related to the number of stages allowed to stack the target object (stacking stage limit), a condition related to the weight that the arrangement object under the target object can endure by placing the object on the arrangement object (for example, in a case where the arrangement object is packed in cardboard, it corresponds to the strength of the cardboard), and the like.

In addition, the acquisition unit 11 acquires information regarding the occupied space of the arrangement object arranged in the candidate arrangement location detected by the sensing unit (not illustrated). The sensing unit (not illustrated) may be, for example, a camera (depth camera, stereo camera, time of flight (ToF) camera, and the like), a laser sensor (2D-LiDAR (Light Detection and Ranging), 3D-LiDAR, and the like), a radar sensor, or the like. Furthermore, for example, in a case where the use case of the arrangement control system 1 is a distribution warehouse, the sensing unit (not illustrated) may be arranged at a position where candidate arrangement locations such as a ceiling or a beam in the warehouse can be overlooked. The number of sensing units (not illustrated) is not particularly limited. A plurality of sensing units (not illustrated) may be dispersedly arranged in a warehouse.

Here, the “arrangement object” means one or a plurality of objects already arranged in the candidate arrangement location. This arranged object or objects may be laid flat or stacked. That is, when the “arrangement object” includes a plurality of objects, the “arrangement object” means a mass of a plurality of objects. Furthermore, the “information regarding the occupied space of the arrangement object” is information indicating the spread of the space in which the arrangement object actually exists, and may be, for example, the height, width, and depth of the arrangement object, and any combination thereof. That is, the “information regarding the occupied space of the arrangement object” can be rephrased as “size information indicating the size of the arrangement object”. Note that the acquisition unit 11 may acquire sensing information from a sensing unit (not illustrated) and acquire information regarding the occupied space of the arrangement object arranged in the candidate arrangement location based on the sensing information.

The determination unit 12 determines whether the target object can be arranged in the candidate arrangement location based on the “upper limit information”, the “target object information”, and the “information regarding the occupied space of the arrangement object” acquired by the acquisition unit 11. As a result, it is possible to determine whether the target object can be arranged in the candidate arrangement location even if the transport apparatus or the person does not actually move to the candidate arrangement location. As a result, it is possible to avoid a case where the target object cannot be arranged in the candidate arrangement location although the target object is actually moved to the candidate arrangement location, so that the transport efficiency can be improved. Furthermore, the “information regarding the occupied space of the arrangement object” is information sensed in real-time by a sensing unit (not illustrated). As a result, it is determined whether the target object can be arranged in the candidate arrangement location based on the up-to-date “information regarding the occupied space of the arrangement object”, so that the determination accuracy can be improved.

More specifically, the determination unit 12 specifies “information regarding the remaining space available for arrangement” based on “upper limit information” and “information regarding the occupied space of the arrangement object”. The “remaining space available for arrangement” means a space left for placing an object in the candidate arrangement location. Furthermore, the “information regarding the remaining space available for arrangement” is information indicating the spread of the remaining space, and may be, for example, an upper limit value regarding the height, width, and depth of the remaining space, and any combination thereof. Then, the determination unit 12 determines whether the target object can be arranged in the candidate arrangement locations based on the “information regarding the remaining space available for arrangement” and the “target object information”. For example, the determination unit 12 determines that the target object can be arranged in the candidate arrangement location if the object having the size indicated by the “target object information” can be accommodated in the remaining space indicated by the “information regarding the remaining space available for arrangement”.

As a specific example, consider a case where all of the “upper limit information”, the “target object information”, and the “information regarding the occupied space of the arrangement object” are information regarding the height. Hereinafter, each of the “upper limit information”, the “target object information”, and the “information regarding the occupied space of the arrangement object” is assumed to be the height upper limit information, the target object height information, and the arrangement object height information.

In this case, determination unit 12 calculates the “arrangeable height” by subtracting the value indicated by the arranged object height information from the value indicated by the height upper limit information. Then, for example, when the “arrangeable height” is larger than the value indicated by the target object height information, the determination unit 12 determines that the target object can be arranged in the candidate arrangement location. Here, the “arrangeable height” means a height of a space left for placing an object in the candidate arrangement location.

Furthermore, as another specific example, a case is considered in which all of the “upper limit information”, the “target object information”, and the “information regarding the occupied space of the arrangement object” are information regarding the width. Hereinafter, each of the “upper limit information”, the “target object information”, and the “information regarding the occupied space of the arrangement object” is assumed to be width upper limit information, target object width information, and arrangement object width information. In this case, determination unit 12 calculates the “arrangeable width” by subtracting the value indicated by the arranged object width information from the value indicated by the width upper limit information. Here, when the target objects are stacked and arranged in the candidate arrangement locations (a case where one or more target objects are not installed on one arrangement object), the determination unit 12 uses 0 as the value indicated by the arranged object width information. This is because the arrangement object does not align with the target object in the width direction, and thus the width of the space in which the target object is placed is not reduced. That is, in this case, the value indicated by the width upper limit information is equal to the “arrangeable width”. Then, for example, when the “arrangeable width” is larger than the value indicated by the target object width information, the determination unit 12 determines that the target object can be arranged in the candidate arrangement location. Here, the “arrangeable width” means a width of a space left for placing an object in the candidate arrangement location. Note that the depth can be handled in the same manner as the width.

Then, the determination unit 12 outputs a determination result. The output determination result may be used as an input of another functional unit in the apparatus provided with the determination unit 12, or may be transmitted from a transmission unit (not illustrated) provided in the apparatus to another apparatus.

### Configuration Example of Arrangement Control Apparatus

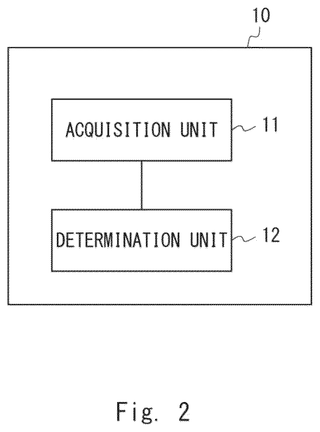

FIG. 2 is a diagram illustrating an example of the arrangement control apparatus according to the first example embodiment. In FIG. 2, the arrangement control apparatus 10 includes an acquisition unit 11 and a determination unit 12. That is, FIG. 2 illustrates an example in which the acquisition unit 11 and the determination unit 12 are provided in the same apparatus. The description of the acquisition unit 11 and the determination unit 12 will be omitted since it is redundant.

The apparatus in which the arrangement control apparatus 10 is arranged is not particularly limited, and for example, the arrangement control apparatus 10 may be provided in a transport apparatus (not illustrated) or may be provided in a management apparatus that manages the transport apparatus (not illustrated). Specific examples will be described later.

### Processing Operation Example

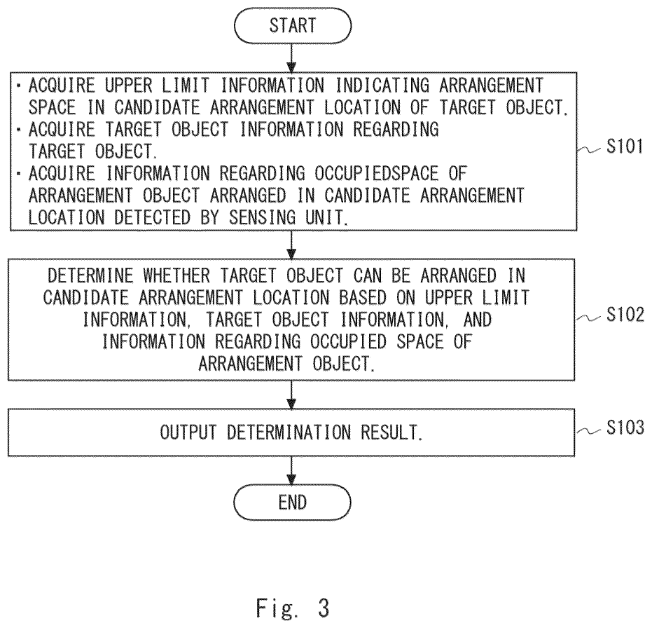

FIG. 3 is a flowchart illustrating an example of a processing operation of the arrangement control system and the arrangement control apparatus of the first example embodiment.

The acquisition unit 11 acquires upper limit information indicating an arrangement space in the candidate arrangement location of the target object (step S101). The acquisition unit 11 acquires target object information on the target object (step S101). The acquisition unit 11 acquires information regarding the occupied space of the arrangement object arranged in the candidate arrangement location detected by the sensing unit (not illustrated) (step S101).

The determination unit 12 determines whether the target object can be arranged in the candidate arrangement location based on the acquired upper limit information, the target object information, and the information regarding the occupied space of the arrangement object (step S102).

The determination unit 12 outputs the determination result (step S103).

### Examples

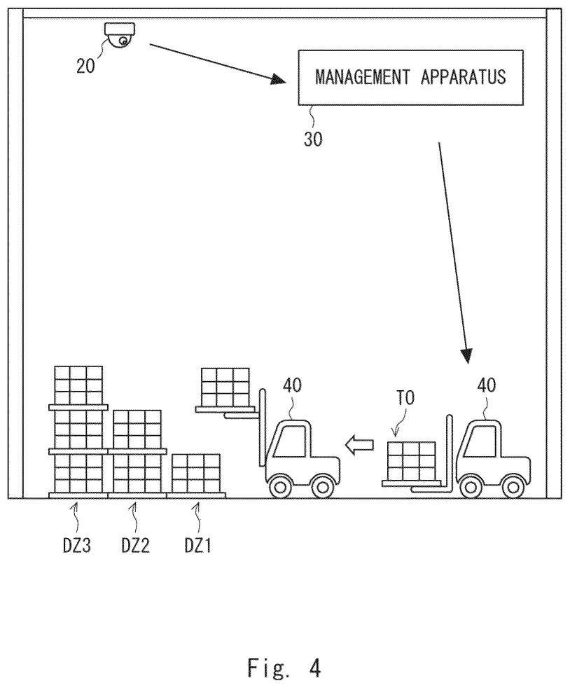

Next, an example of the arrangement control system according to the first example embodiment will be described. FIG. 4 is a diagram for explaining an example of the arrangement control system in the first example embodiment.

FIG. 4 illustrates a management system in a warehouse as an example. In FIG. 4, the management system includes a sensor 20, a management apparatus 30, and a transport apparatus 40. As described above, the apparatus in which the arrangement control apparatus 10 of the first example embodiment is arranged is not particularly limited, but here, the description will be given assuming that the arrangement control apparatus 10 is arranged in the management apparatus 30. In addition, here, the description will be given on the assumption that the transport apparatus 40 is a forklift as an example. In addition, a description will be given on the assumption that the “target object” is a pallet on which a luggage is loaded (hereinafter, simply referred to as a “palette”). This pallet is shown in FIG. 4 as Pallet TO.

Here, the sensor 20 may be, for example, a camera (depth camera, stereo camera, time of flight (ToF) camera, and the like), a laser sensor (2D-LiDAR (Light Detection and Ranging), 3D-LiDAR, and the like), a radar sensor, or the like. The sensor 20 may transmit the sensing information to the management apparatus 30 via a network (not illustrated). The type of the network is not particularly limited, and may be, for example, a network such as 3rd generation (3G), long term evolution (LTE), 4G, 5G, or local 5G, a wireless local area network (for example, Wi-Fi (registered trademark)), a wired LAN, or a low power wide area network (LPWAN). In addition, the sensor 20 may be arranged at a position (for example, a ceiling and a beam) where candidate arrangement locations in an area where the transport apparatus 40 can transport (here, the warehouse) can be overlooked. The number of sensors 20 is not particularly limited. The plurality of sensors 20 may be dispersedly arranged in the transportable area.

For example, the management apparatus 30 may collect the following information by the acquisition unit 11. The timing of collecting the information is not particularly limited, and may be performed, for example, before the operation of the transport apparatus 40 or may be performed as needed during the operation of the transport apparatus 40.

For example, the management apparatus 30 may collect “map information” in an area where the transport apparatus 40 can transport (here, the warehouse). The “map information” is information related to an attribute of each location in the transportable area. For example, it is assumed that the transportable area is divided into a plurality of zones (that is, the zone), and each zone is divided into a plurality of partial zones. The map information may include, for example, information indicating in which zone luggage may be placed. Furthermore, the map information may include information indicating the status of the luggage already placed. This information may be, for example, information indicating that the product A is arranged in the partial zone b1.

In addition, the map information may include information indicating a position of a shelf, information indicating a location where a truck stops, information indicating an inspection location, information indicating a disassembly location, information indicating an entry prohibition zone, and the like.

In addition, the management apparatus 30 may collect the above-described “upper limit information indicating the arrangement space”.

In addition, the management apparatus 30 may collect information regarding a luggage as a target object. The “information associated with luggage” may include information associated with a kind of luggage (for example, the product name), the above-described “arrangement condition”, delivery customer information, or the like. In addition, the management apparatus 30 may collect information regarding luggage to be placed in each zone.

### Start of Operation of Transport Apparatus

The transport apparatus 40 adjusts the state of the fork unit. For example, the transport apparatus 40 moves the position of the fork unit to a position for lifting the pallet.

In addition, the transport apparatus 40 may identify a luggage on the transport target pallet and notify the management apparatus 30 of the identification information of the luggage. For example, the transport apparatus 40 may include a reader (not illustrated), and may acquire the identification information of the package by reading a QR code (registered trademark) or a barcode using the reader (not illustrated). As a result, the management apparatus 30 can acquire the information on the luggage on the transport target palette. Note that the method by which the management apparatus 30 acquires the information on the luggage on the transport target palette is not limited thereto, and for example, the luggage on the transport target palette may be determined based on sensing information (for example, an image of the transport apparatus 40) of the sensor 20.

### Selection of Arrangement Location

The acquisition unit 11 of the management apparatus 30 acquires, for example, “information regarding the occupied space of the arrangement object” in real-time from the sensor 20 via a network (not illustrated). As described above, the “information regarding the occupied space of the arrangement object” may be, for example, the height, width, and depth of the arrangement object, and any combination thereof.

As described above, the acquisition unit 11 may acquire the sensing information regarding the candidate arrangement location from the sensor 20 in real time, and acquire the information regarding the occupied space of the arrangement object arranged in the candidate arrangement location based on the sensing information. For example, in a case where the sensing information is an image, the acquisition unit 11 may specify the “information regarding the occupied space of the arrangement object” by image processing. For example, in a case where the sensor 20 is a stereo camera or the like and the sensing information is a stereo image, the acquisition unit 11 may form a distance image from the stereo image and specify the “information regarding the occupied space of the arrangement object” based on the distance image. Furthermore, for example, in a case where the sensor 20 is a laser sensor or the like and the sensing information is a distance image, the acquisition unit 11 may specify “information regarding the occupied space of the arrangement object” based on the distance image.

Here, the upper limit information is the number (number of stages) of pallets allowed to be stacked, and is three (three stages). In addition, the “information regarding the occupied space of the arrangement object” is the number of pallets (the number of stages) already arranged in the candidate arrangement location.

The determination unit 12 of the management apparatus 30 specifies “information regarding the remaining space available for arrangement” based on the “upper limit information” and the “information regarding the occupied space of the arrangement object”. Here, both the “upper limit information” and the “information regarding the occupied space of the arrangement object” are the number of pallets. Therefore, the determination unit 12 may further specify the number of pallets that can be stacked by subtracting the number of pallets already arranged in the candidate arrangement location from the number of pallets allowed to be stacked in the candidate arrangement location. For example, when each of the partial zones DZ1, DZ2, and DZ3 is set as a candidate arrangement location as illustrated in FIG. 4, the determination unit 12 determines that the arrangement target palette cannot be arranged in the partial zone DZ3 in which three palettes are already stacked. On the other hand, since there is still room for stacking pallets in the partial zones DZ2 and DZ3, the determination unit 12 determines that the arrangement target pallets can be arranged in the partial zones DZ2 and DZ3.

In addition, the determination unit 12 may determine that the target object can be arranged in the candidate arrangement location when there is a space to arrange the target object in the candidate arrangement location and the above-described “arrangement condition” is satisfied. For example, in a case where the arrangement condition of the arrangement object of a certain candidate arrangement location includes a condition of “stacking prohibited”, the determination unit 12 may determine that the target object cannot be arranged in the candidate arrangement location even if there is a space to spare in the candidate arrangement location.

Note that the determination unit 12 may determine the target zone based on the target object information or the arrangement condition, and narrow the candidate arrangement locations to be determined to those in the target zone. For example, in a case where the target object is a luggage addressed to a customer in a predetermined area, the determination unit 12 may narrow the candidate arrangement location to be determined to a cargo bed of a truck heading for the area. Furthermore, for example, in a case where the arrangement condition of the target object includes a condition of “stacking prohibited”, the determination unit 12 may narrow the candidate arrangement locations to be determined to those in the horizontal-exclusive zone.

### Notification of Candidate Arrangement Locations

Information indicating the determination result (for example, a candidate arrangement location determined to be arrangeable) may be notified to the transport apparatus 40 or an operator apparatus operated by the operator. This notification will be described in detail in the third example embodiment.

In a case where the transport apparatus 40 can autonomously operate, the transport apparatus 40 moves to the notified candidate arrangement location. In addition, when the transport apparatus 40 is a boarding type or a remote control type, the driver or the operator performs an operation of moving the transport apparatus 40 to the notified candidate arrangement location.

As described above, according to the first example embodiment, in the arrangement control system 1, the acquisition unit 11 acquires the upper limit information indicating the arrangement space in the candidate arrangement locations of the target object and the target object information including the size information indicating the size of the target object. In addition, the acquisition unit 11 acquires information regarding the occupied space of the arrangement object arranged in the candidate arrangement location detected by the sensing unit (for example, the sensor 20). The determination unit 12 determines whether the target object can be arranged in the candidate arrangement location based on the upper limit information, the target object information, and the information regarding the occupied space of the arrangement object acquired by the acquisition unit 11.

With the configuration of the arrangement control system 1, it is possible to acquire “information regarding the occupied space of the arrangement object” sensed in real-time by the sensing unit (not illustrated). As a result, it is determined whether the target object can be arranged in the candidate arrangement location based on the up-to-date “information regarding the occupied space of the arrangement object”, so that the determination accuracy can be improved. With the configuration of the arrangement control system 1, it is possible to determine whether the target object can be arranged in the candidate arrangement location even if the transport apparatus or the person does not actually move to the candidate arrangement location. As a result, it is possible to avoid a case where the target object cannot be arranged in the candidate arrangement location although the target object is actually moved to the candidate arrangement location, so that the transport efficiency can be improved.

It is also conceivable that the candidate arrangement locations and the information regarding the occupied space of the arrangement object are acquired in advance and managed in association with each other. However, the situation of the candidate arrangement location of the warehouse or the like is likely to fluctuate, and complicated management is required. On the other hand, since the arrangement control system 1 acquires “information regarding the occupied space of the arrangement object” sensed in real-time by the sensing unit (not illustrated), it is also advantageous in that complicated management becomes unnecessary.

### Second Example Embodiment

The second example embodiment relates to an example embodiment that is particularly useful in a case where there is a plurality of candidate arrangement locations in which a target object can be arranged.

### Arrangement Control System

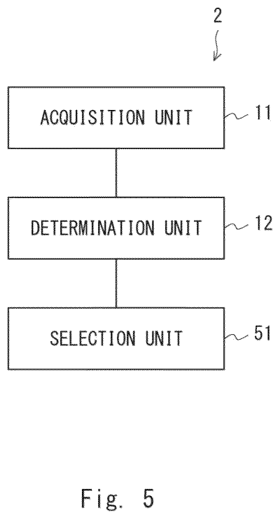

FIG. 5 is a diagram illustrating an example of an arrangement control system according to the second example embodiment. In FIG. 5, the arrangement control system 2 includes an acquisition unit 11, a determination unit 12, and a selection unit 51. Note that, in the arrangement control system 2, the acquisition unit 11, the determination unit 12, and the selection unit 51 may be provided in the same apparatus. Furthermore, the acquisition unit 11, the determination unit 12, and the selection unit 51 may be provided independently of each other, and may be provided on different apparatuses or a cloud, for example. For example, the acquisition unit 11 and the determination unit 12 may be provided in the same apparatus, and the selection unit 51 may be provided in different apparatuses. That is, the arrangement positions of the acquisition unit 11, the determination unit 12, and the selection unit 51 are not particularly limited.

In the second example embodiment, the acquisition unit 11 acquires “upper limit information” in each of a plurality of candidate arrangement locations in an area (hereinafter, simply referred to as a “transportable area”) in which a transport apparatus (not illustrated) can transport a target object. The “transportable area” is an area where a transport apparatus (not illustrated) that transports a target object can exist. For example, in a case of a use case in which the arrangement control system 2 is used for a warehouse, the “transportable area” may be an entire area of the warehouse or a partial area. Furthermore, the “upper limit information indicating the arrangement space” is information indicating the spread of the arrangement space as described above, and may be, for example, an upper limit value regarding the height, width, and depth of the arrangement space, and any combination thereof.

In the second example embodiment, for each candidate arrangement location, the determination unit 12 determines whether the target object can be arranged in each candidate arrangement location based on the upper limit information, the target object information, and the information regarding the occupied space of the arrangement object. Therefore, there may be a plurality of candidate arrangement locations in which the target object can be arranged.

The selection unit 51 selects a candidate arrangement location satisfying the “arrangement condition” from among one or more candidate arrangement locations in which it is determined that the target object can be arranged. As described above, the “arrangement condition” means an additional condition to be satisfied when the target object is arranged in the candidate arrangement location. That is, the selection unit 51 selects a candidate arrangement location that satisfies the arrangement condition except for a candidate arrangement location that does not satisfy the arrangement condition even if the candidate arrangement location is determined to be able to spatially arrange the object by the determination unit 12. Accordingly, a more suitable arrangement location can be selected.

### Configuration Example of Arrangement Control Apparatus

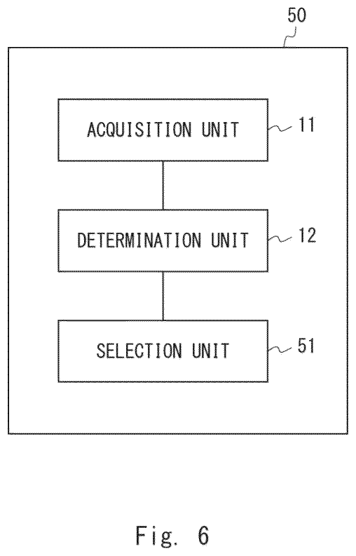

FIG. 6 is a diagram illustrating an example of an arrangement control apparatus according to a second example embodiment. In FIG. 6, the arrangement control apparatus 50 includes an acquisition unit 11, a determination unit 12, and a selection unit 51. That is, FIG. 6 illustrates an example in which the acquisition unit 11, the determination unit 12, and the selection unit 51 are provided in the same apparatus. The description of the acquisition unit 11, the determination unit 12, and the selection unit 51 will be omitted since it is redundant.

The apparatus in which the arrangement control apparatus 50 is arranged is not particularly limited, and for example, the arrangement control apparatus 50 may be provided in a transport apparatus (for example, the transport apparatus 40) or may be provided in a management apparatus (for example, the management apparatus 30) that manages the transport apparatus.

### Processing Operation Example

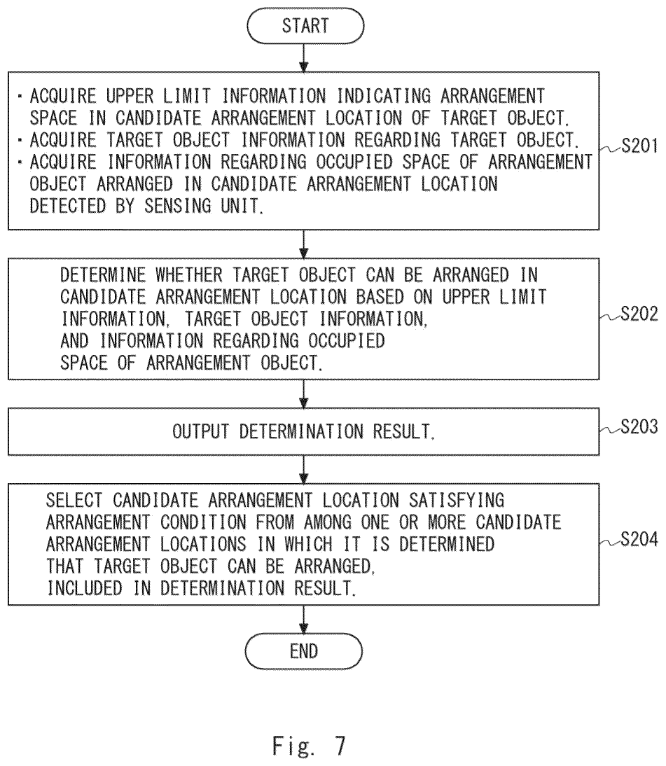

FIG. 7 is a flowchart illustrating an example of a processing operation of the arrangement control system and the arrangement control apparatus according to the second example embodiment.

The acquisition unit 11 acquires “upper limit information” in each of the plurality of candidate arrangement locations in the transportable area (step S201). The acquisition unit 11 acquires target object information on the target object (step S201). The acquisition unit 11 acquires information regarding the occupied space of the arrangement object arranged in each candidate arrangement location detected by the sensing unit (not illustrated) (step S201).

For each candidate arrangement location, the determination unit 12 determines whether the target object can be arranged in each candidate arrangement location based on the upper limit information, the target object information, and the information regarding the occupied space of the arrangement object (step S202).

The determination unit 12 outputs the determination result (step S203).

The selection unit 51 selects a candidate arrangement location satisfying the “arrangement condition” from among one or more candidate arrangement locations in which it has been determined that the target object can be arranged, included in the determination result (step S204).

Here, the selected candidate arrangement location may be notified to the transport apparatus or the operator apparatus operated by the operator. This notification will be described in detail in the third example embodiment.

Then, in a case where the transport apparatus can autonomously operate, the transport apparatus moves to the notified candidate arrangement location. Further, when the transport apparatus is a boarding type or a remote control type, the driver or the operator performs an operation of moving the transport apparatus to the notified candidate arrangement location.

As described above, according to the second example embodiment, in the arrangement control system 2, the selection unit 51 selects the candidate arrangement location satisfying the “arrangement condition” from among one or more candidate arrangement locations for which it has been determined that the target object can be arranged. The “arrangement condition” is an additional condition to be satisfied when the target object is arranged in the candidate arrangement location.

With the configuration of the arrangement control system 2, a more suitable arrangement location can be selected.

### Third Example Embodiment

The third example embodiment relates to the notification of information regarding candidate arrangement locations.

### Arrangement Control System

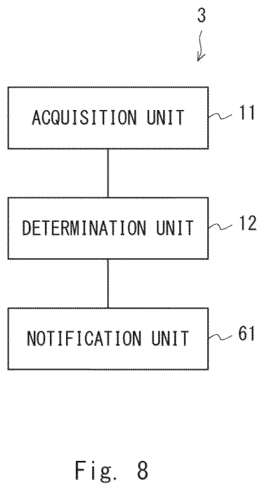

FIG. 8 is a diagram illustrating an example of an arrangement control system according to a third example embodiment. In FIG. 8, the arrangement control system 2 includes an acquisition unit 11, a determination unit 12, and a notification unit 61. Note that, in the arrangement control system 3, the acquisition unit 11, the determination unit 12, and the notification unit 61 may be provided in the same apparatus. Furthermore, the acquisition unit 11, the determination unit 12, and the notification unit 61 may be provided independently of each other, and may be provided on different apparatuses or a cloud, for example. That is, the arrangement positions of the acquisition unit 11, the determination unit 12, and the notification unit 61 are not particularly limited. Since the acquisition unit 11 and the determination unit 12 are the same as those in the first example embodiment and the second example embodiment, the description thereof will be omitted.

For example, the notification unit 61 generates a control signal including information indicating the determination result from the determination unit 12, and notifies (transmits) the notification destination of the control signal. The notification destination may be, for example, a transport apparatus (not illustrated) or an operating apparatus (not illustrated). For example, the information indicating the determination result included in the control signal may be information indicating the position of the candidate arrangement location determined to be arrangeable by the determination unit 12. The information indicating the position of the candidate arrangement location may be, for example, position identification information attached to each position in the area. The position identification information may be, for example, identification information of a zone in which the area is divided, or identification information of a partial zone in which the zone is divided.

Furthermore, for example, the information indicating the determination result included in the control signal may be map information indicating whether the target object can be arranged with respect to the candidate arrangement location.

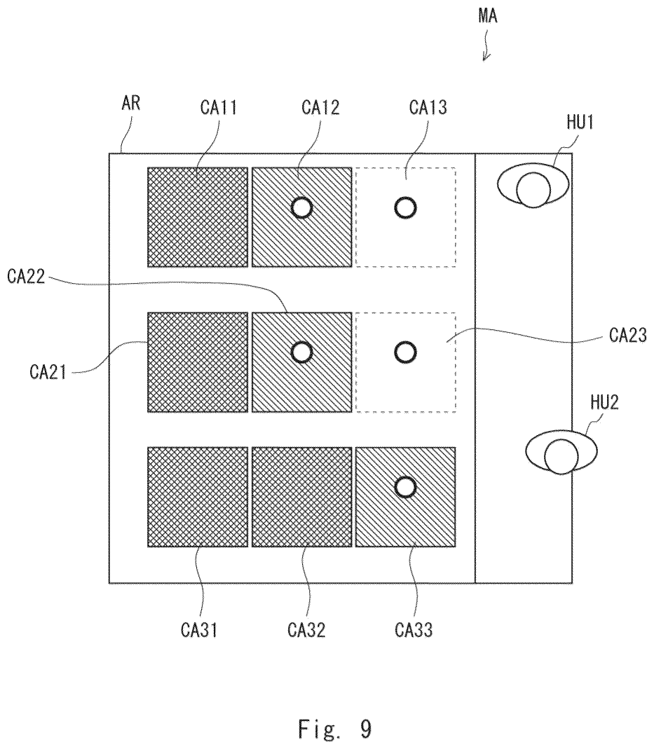

FIG. 9 is a diagram illustrating an example of map information to be notified. The map information MA illustrated in FIG. 9 indicates the transportable area AR. In the transportable area AR, candidate arrangement locations CA11, CA12, CA13, CA21, CA22, CA23, CA31, CA32, and CA33 are indicated by rectangles, respectively. Then, a circle is written in the rectangle corresponding to the candidate arrangement location in which it is determined that the target object can be arranged, and a circle is not written in the rectangle corresponding to the candidate arrangement location determined to be unable to arrange the target object. In addition, even if it is determined that both the first candidate arrangement location and the second candidate arrangement location can arrange the target object, the display mode of the first candidate arrangement location and the display mode of the second candidate arrangement location are different depending on whether the arrangement object already exists. For example, the candidate arrangement location CA11 is a candidate arrangement location for which it is determined that the target object cannot be arranged. In addition, for example, the candidate arrangement location CA12 is a candidate arrangement location in which it is determined that the target object can be arranged, but the arrangement object already exists. In addition, for example, the candidate arrangement location CA13 is a candidate arrangement location in which it is determined that the target object can be arranged and the arrangement object does not exist yet. Note that, for example, the candidate arrangement locations CA11, CA12, and CA13 may form a zone or a partial zone, or the candidate arrangement locations CA11, CA12, CA13, CA21, CA22, CA23, CA31, CA32, and CA33 may form a zone or a partial zone.

Note that variations of the method of changing the display mode according to the attribute of the candidate arrangement location include a method of changing colors (color coding), a method of changing display marks, and a method of using highlight display (for example, a method of surrounding with a thick frame or blinking the surrounded frame).

In a case where the transport apparatus (not illustrated) that has received such map information can autonomously operate, the transport apparatus transports the target object to the arrangeable candidate arrangement location indicated in the map information. When a plurality of arrangeable candidate arrangement locations are shown as in FIG. 9, the transport apparatus (not shown) may autonomously select one of the plurality of candidate arrangement locations and transport the target object to the selected candidate arrangement location. Further, the boarding-type transport apparatus (not illustrated) may display map information on a display unit provided in the transport apparatus (not illustrated), for example. As a result, the operator of the transport apparatus (not illustrated) can recognize the arrangeable candidate arrangement locations indicated in the displayed map information.

Further, the map information MA may indicate the persons HU1 and HU2 at positions detected by a sensing unit (not illustrated). As a result, the autonomously movable transport apparatus (not illustrated) can move while avoiding contact with the illustrated person. Thus, in the boarding-type transport apparatus (not illustrated), the operator can recognize the presence of a person by viewing the displayed map information. As a result, the boarding-type transport apparatus (not illustrated) can be operated safely.

Note that, in a case where the transport apparatus (not illustrated) is a remote control type, the notification unit 61 may notify an operating apparatus (not illustrated) of the map information. Then, the operating apparatus (not illustrated) may display the map information on a display unit provided in the operating apparatus (not illustrated). As a result, an operator of the transport apparatus (not illustrated) can recognize the arrangeable candidate arrangement locations indicated in the displayed map information.

### Configuration Example of Arrangement Control Apparatus

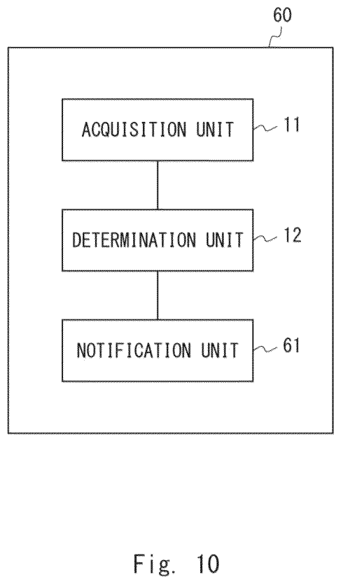

FIG. 10 is a diagram illustrating an example of an arrangement control apparatus according to a third example embodiment. In FIG. 10, the arrangement control apparatus 60 includes an acquisition unit 11, a determination unit 12, and a notification unit 61. That is, FIG. 10 illustrates an example in which the acquisition unit 11, the determination unit 12, and the notification unit 61 are provided in the same apparatus. The description of the acquisition unit 11, the determination unit 12, and the notification unit 61 will be omitted since it is redundant.

The apparatus in which the arrangement control apparatus 60 is arranged is not particularly limited, and for example, the arrangement control apparatus 60 may be provided in a transport apparatus (for example, the transport apparatus 40) or may be provided in a management apparatus (for example, the management apparatus 30) that manages the transport apparatus.

### Processing Operation Example

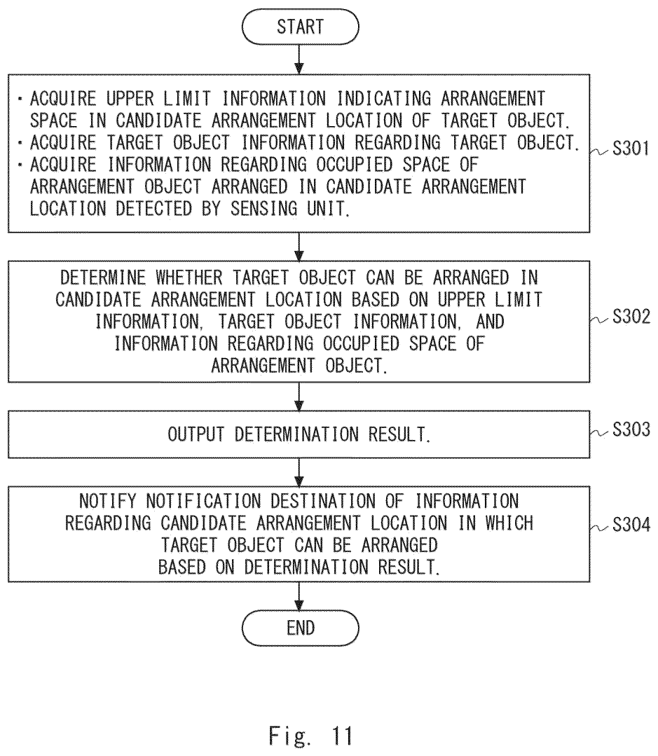

FIG. 11 is a flowchart illustrating an example of the processing operation of the arrangement control system and the arrangement control apparatus according to the third example embodiment.

The acquisition unit 11 acquires “upper limit information” in each of the plurality of candidate arrangement locations in the transportable area (step S301). The acquisition unit 11 acquires target object information on the target object (step S301). The acquisition unit 11 acquires information regarding the occupied space of the arrangement object arranged in each candidate arrangement location detected by the sensing unit (not illustrated) (step S301).

For each candidate arrangement location, the determination unit 12 determines whether the target object can be arranged in each candidate arrangement location based on the upper limit information, the target object information, and the information regarding the occupied space of the arrangement object (step S302).

The determination unit 12 outputs the determination result (step S303).

The notification unit 61 notifies the notification destination of information regarding the candidate arrangement location in which the target object can be arranged based on the determination result (step S304).

As described above, according to the third example embodiment, in the arrangement control system 3, the notification unit 61 notifies the notification destination of the information regarding the candidate arrangement location in which the target object can be arranged.

With the arrangement control system 3, it is possible to recognize the arrangeable location in the notification destination.

Note that, in the above description, a system in which the notification unit 61 is applied to the arrangement control system 1 of the first example embodiment has been described as the arrangement control system 3. The system to which the notification unit 61 is applied is not limited to this, and may be the arrangement control system 2 of the second example embodiment. In this case, the notification unit 61 may notify the notification destination of information regarding the candidate arrangement location selected by the selection unit 51. As an aspect of the notification, those described in the third example embodiment can be applied.

### Fourth Example Embodiment

The fourth example embodiment relates to an example embodiment in which “information regarding the pose of the arrangement object” is used for determining whether the target object can be arranged as the candidate arrangement location.

### Arrangement Control System

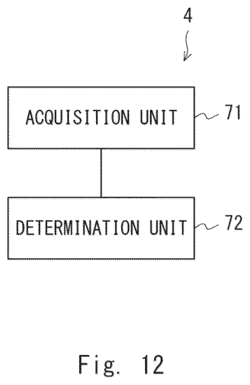

FIG. 12 is a diagram illustrating an example of an arrangement control system according to a fourth example embodiment. In FIG. 12, the arrangement control system 4 includes an acquisition unit 71 and a determination unit 72. Note that, in the arrangement control system 4, the acquisition unit 71 and the determination unit 72 may be provided in the same apparatus. Furthermore, the acquisition unit 71 and the determination unit 72 may be provided independently of each other, and for example, may be provided on different apparatuses or on a cloud. That is, the arrangement positions of the acquisition unit 71 and the determination unit 72 are not particularly limited.

The acquisition unit 71 acquires the following information similarly to the acquisition unit 11 of the first to third example embodiments. That is, the acquisition unit 71 acquires “upper limit information indicating an arrangement space” in a “candidate arrangement location” of a “target object”. Furthermore, the acquisition unit 71 acquires “target object information” regarding the target object. In addition, the acquisition unit 71 acquires information regarding the occupied space of the arrangement object arranged in the candidate arrangement location detected by the sensing unit (not illustrated).

Then, the acquisition unit 71 acquires “information regarding the pose of the arrangement object” arranged in the candidate arrangement locations.

Here, the “pose of the arrangement object” means the state of arrangement of the arrangement object. The “information regarding the pose of the arrangement object” refers to information used to determine the pose of the arrangement object. For example, the “information regarding the pose of the arrangement object” may be a direction in which the entire or a part of the arrangement object extends with respect to the reference surface or the reference direction. For example, the inclination of the arrangement object itself with respect to the horizontal plane or the inclination of the upper surface of the arrangement object with respect to the horizontal plane may be used as the “information regarding the pose of the arrangement object”. Alternatively, the “information regarding the pose of the arrangement object” may be a position where the entire or a part of the arrangement object exists with respect to the reference surface or the reference position. For example, when the arrangement object is a plurality of stacked objects, the horizontal displacement of the lower surface of the upper object with respect to the upper surface of the lower object may be used as the “information regarding the pose of the arrangement object”.

Note that the “pose of the arrangement object” may be detected by a sensing unit (not illustrated). The sensing unit (not illustrated) may be, for example, a camera (depth camera, stereo camera, time of flight (ToF) camera, and the like), a laser sensor (2D-LiDAR (Light Detection and Ranging), 3D-LiDAR, and the like), a radar sensor, or the like. Furthermore, for example, in a case where the use case of the arrangement control system 1 is a distribution warehouse, the sensing unit (not illustrated) may be arranged at a position (for example, a ceiling or a beam) where candidate arrangement locations in the warehouse can be overlooked. The number of sensing units (not illustrated) is not particularly limited. A plurality of sensing units (not illustrated) may be dispersedly arranged in a warehouse. Furthermore, the sensing unit (not illustrated) may be provided in a transport apparatus (not illustrated). In a case where the transport apparatus (not illustrated) is a forklift, the sensing unit (not illustrated) may be arranged on a tip of a claw, a root of the claw, an upper portion of a passenger seat, or the like.

The determination unit 72 determines whether the target object can be arranged on the arrangement object based on the upper limit information, the target object information, the information regarding the occupied space of the arrangement object, and the information regarding the pose of the arrangement object. For example, even when it can be determined that the target object can be spatially arranged as the candidate arrangement location based on the upper limit information, the target object information, and the information regarding the occupied space of the arrangement object, the determination unit 72 determines that the arrangement is impossible depending on the pose of the arrangement object indicated by the information regarding the pose of the arrangement object.

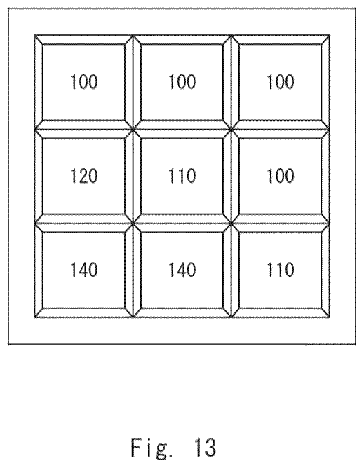

For example, it is assumed that the acquisition unit 71 acquires “information regarding the pose of the arrangement object” indicating that the upper surface of the arrangement object is not flat as illustrated in FIG. 13. FIG. 13 is a schematic view of the arrangement object as viewed from above. The nine rectangles illustrated in FIG. 13 represent, for example, nine detection blocks obtained by dividing a detection range of a sensing unit (not illustrated). Then, for example, the detection range illustrated in FIG. 13 may be the upper surface of the arrangement object. At this time, the numbers shown in FIG. 13 represent the distances from the respective parts on the upper surface of the arrangement object to the ceiling.

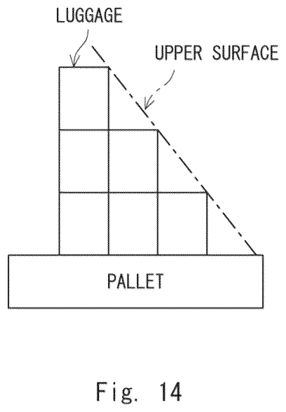

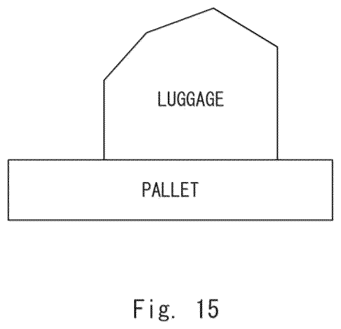

In the example illustrated in FIG. 13, when the pose of the arrangement object is determined from the information on the distance from each part of the upper surface of the arrangement object to the ceiling, the upper surfaces of the loads to which the numerical values “100” are attached are aligned. However, the upper surface of the article to which the numerical value “110” is attached is positioned below the upper surface of the article to which the numerical value “100” is attached when viewed from above. Therefore, there is a step between the upper surface of the article to which the numerical value “100” is attached and the upper surface of the article to which the numerical value “110” is attached. Further, there is also a step between the upper surface of the article to which the numerical value “110” is attached and the upper surface of the article to which the numerical value “120” or the numerical value “140” is attached. That is, the upper surface of the arrangement object in the example illustrated in FIG. 13 is inclined like the upper surface of the target object illustrated in FIG. 14, for example. Arranging the target object on such an arrangement object is dangerous because the target object is arranged in an unstable state. Therefore, the determination unit 72 determines that the target object cannot be arranged in the candidate arrangement locations based on the “information regarding the pose of the arrangement object” indicating that the upper surface of the arrangement object is not flat. FIG. 14 is a view illustrating an example of an upper surface of the arrangement object. Note that, here, a case where one detection block and the upper surface of one luggage coincide with each other has been described as an example, but the present invention is not limited thereto. For example, as illustrated in FIG. 15, it is also conceivable that the arrangement object includes one load, and the upper surface of the load is inclined. Also in this case, for example, it can be seen that the upper surface of the load is inclined from the information of the distance from each part of the upper surface of the load to the ceiling. Therefore, the determination unit 72 determines that the target object cannot be arranged in the candidate arrangement locations based on the “information regarding the pose of the arrangement object” indicating that the upper surface of the arrangement object is not flat. FIG. 15 is a view illustrating another example of the upper surface of the arrangement object.

In addition, a case where the arrangement object includes a first object and a second object stacked on the first object will be described. For example, it is assumed that each of the first object and the second object is a pallet and a load placed on the pallet. Even when the acquisition unit 71 acquires “information regarding the pose of the arrangement object” indicating that the lower surface of the upper second object is displaced in the horizontal direction with respect to the upper surface of the lower first object, the second object is arranged on the first object in an unstable state in the arrangement object. Since it is dangerous to arrange a target object on such an arrangement object (that is, on the second object), the determination unit 72 determines that the target object cannot be arranged in the candidate arrangement location.

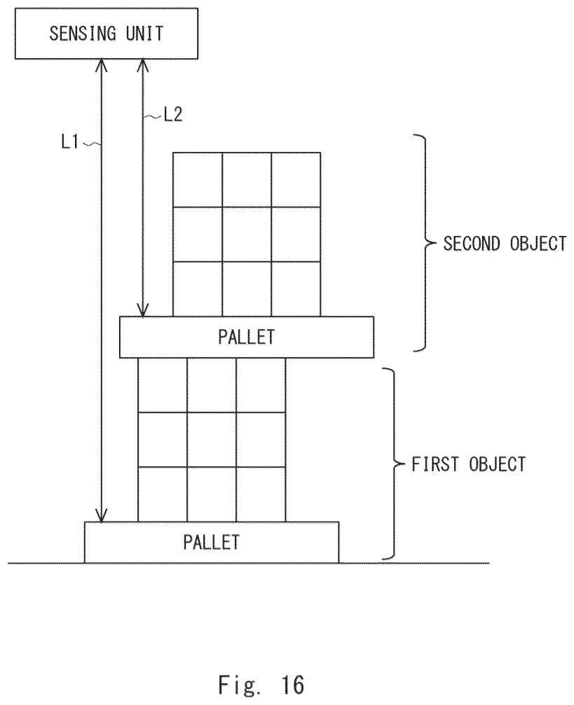

FIG. 16 is a view for describing a deviation between the first object and the second object constituting the arrangement object. In general, it is considered that pallets used at one location are common. Therefore, if there is no deviation between the first object and the second object, the pallet of the first object is ideally not visible because it overlaps the pallet of the second object when viewed from above. Therefore, in a case where there is a deviation between the first object and the second object as illustrated in FIG. 16, when the depth camera is used as the sensing unit, the first depth L1 from the depth camera to the palette of the first object and the second depth L2 from the depth camera to the palette of the second object are detected as the depths related to the arrangement object. Note that the depth to the floor is known, and the first depth L1 and the second depth L2 are smaller than the depth to the floor.

The determination unit 72 may determine that the target object cannot be arranged in the candidate arrangement location even in a case where a plurality of different depths as depths of the arrangement object is received as “information regarding the pose of the arrangement object” indicating that the lower surface of the upper second object is shifted in the horizontal direction with respect to the upper surface of the lower first object.

### Configuration Example of Arrangement Control Apparatus

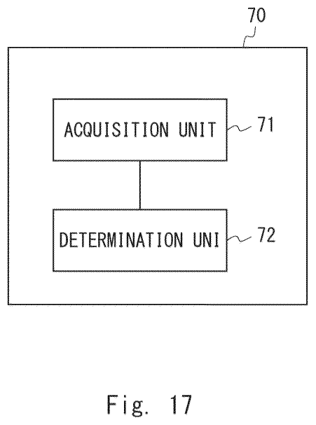

FIG. 17 is a diagram illustrating an example of an arrangement control apparatus according to the fourth example embodiment. In FIG. 17, the arrangement control apparatus 70 includes an acquisition unit 71 and a determination unit 72. That is, FIG. 17 illustrates an example in which the acquisition unit 71 and the determination unit 72 are provided in the same apparatus. The description of the acquisition unit 71 and the determination unit 72 will be omitted since it is redundant.

The apparatus in which the arrangement control apparatus 70 is arranged is not particularly limited, and for example, the arrangement control apparatus 70 may be provided in a transport apparatus (not illustrated) or may be provided in a management apparatus that manages the transport apparatus (not illustrated).

### Processing Operation Example

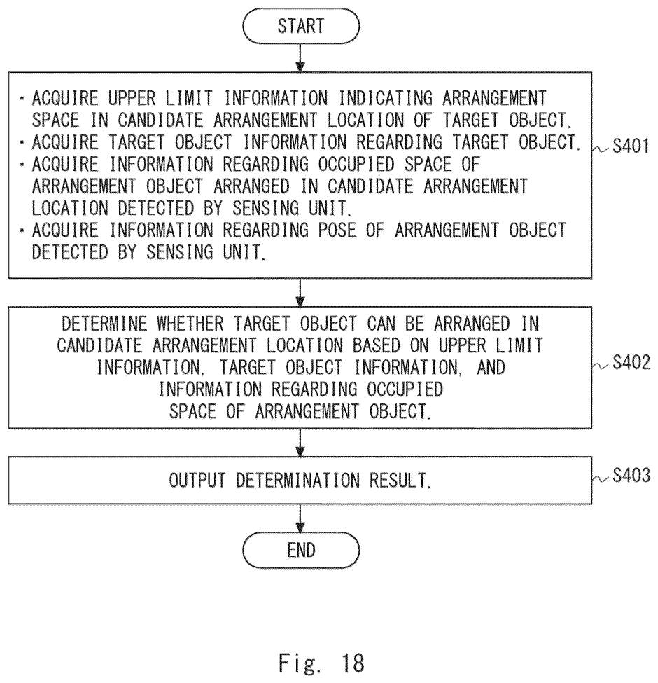

FIG. 18 is a flowchart illustrating an example of the processing operation of the arrangement control system and the arrangement control apparatus according to the fourth example embodiment.

The acquisition unit 71 acquires upper limit information indicating an arrangement space in the candidate arrangement location of the target object (step S401). The acquisition unit 71 acquires target object information on the target object (step S401). The acquisition unit 71 acquires information regarding the occupied space of the arrangement object arranged in the candidate arrangement location detected by the sensing unit (not illustrated) (step S401). The acquisition unit 71 acquires information regarding the pose of the arrangement object detected by the sensing unit (not illustrated) (step S401).

The determination unit 72 determines whether the target object can be arranged in the candidate arrangement location based on the acquired upper limit information, target object information, information regarding the occupied space of the arrangement object, and information regarding the pose of the arrangement object (step S402).

The determination unit 72 outputs the determination result (step S403).

As described above, according to the fourth example embodiment, in the arrangement control system 4, the acquisition unit 71 acquires the upper limit information indicating the arrangement space and the target object information including the size information indicating the size of the target object in the candidate arrangement locations of the target object. In addition, the acquisition unit 71 acquires information regarding the occupied space of the arrangement object arranged in the candidate arrangement location detected by the sensing unit. Furthermore, the acquisition unit 71 acquires information regarding the pose of the arrangement object detected by the sensing unit. The determination unit 72 determines whether the target object can be arranged in the candidate arrangement location based on the upper limit information, the target object information, and the information regarding the pose of the arrangement object acquired by the acquisition unit 71.

With the configuration of the arrangement control system 4, it is possible to determine whether arrangement is possible in consideration of safety in the candidate arrangement locations.

In the second example embodiment and the third example embodiment, the acquisition unit 71 and the determination unit 12 can be applied instead of the acquisition unit 11 and the determination unit 72.

The first to fourth example embodiments described above can be combined in any combination. In addition, contents common between the example embodiments may be omitted, but the contents of one example embodiment can be used in another example embodiment.

### OTHER EXAMPLE EMBODIMENTS

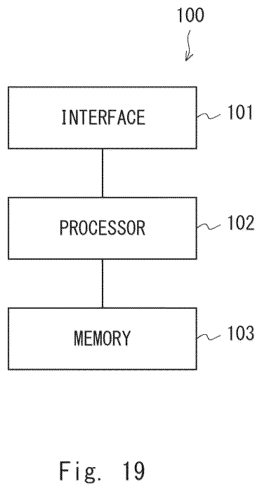

FIG. 19 is a diagram illustrating a hardware configuration example of the arrangement control apparatus. In FIG. 19, the arrangement control apparatus 100 includes an interface 101, a processor 102, and a memory 103. The interface 101 may be used to communicate with a network node (e.g., eNB, MME, P-GW). The interface 101 may include, for example, a network interface card (NIC) conforming to IEEE 802.3 series. Here, the eNB represents an evolved node B, the MME represents a mobility management entity, and the P-GW represents a packet data network gateway. IEEE represents Institute of Electrical and Electronics Engineers.

The processor 102 may be, for example, a microprocessor, a micro processing unit (MPU), or a central processing unit (CPU). The processor 102 may include a plurality of processors. The memory 103 is configured by a combination of a volatile memory and a nonvolatile memory. The memory 103 may include a storage located away from the processor 102. In this case, the processor 102 may access the memory 103 through an I/O interface (not illustrated).

In the example of FIG. 19, the memory 103 is used to store a software module group. The processor 102 can perform the processing of the arrangement control apparatus 10 and the like described in the above-described example embodiment by reading and executing these software module groups from the memory 103.

Each of the arrangement control apparatuses 10, 50, 60, and 70 according to the first to fourth example embodiments can have the hardware configuration illustrated in FIG. 19. The acquisition units 11 and 71, the determination units 12 and 72, the selection unit 51, and the notification unit 61 of the arrangement control apparatuses 10, 50, 60, and 70 according to the first to fourth example embodiments may be implemented by the processor 102 reading and executing a program stored in the memory 103. That is, each of the processors included in the arrangement control apparatuses 10, 50, 60, and 70 executes one or a plurality of programs including a command group for causing a computer to perform the algorithm described with reference to the drawings.

The programs can be stored using various types of non-transitory computer-readable media and supplied to the arrangement control apparatuses 10, 50, 60, and 70. Examples of non-transitory computer-readable media include random-access memory (RAM), read-only memory (ROM), flash memory, solid-state drive (SSD) or other memory technology, CD-ROM, digital versatile disc (DVD), Blu-ray (registered trademark) disk or other optical disk storage, magnetic cassettes, magnetic tape, magnetic disk storage, or other magnetic storage apparatuses. Furthermore, the program may be supplied to the arrangement control apparatuses 10, 50, 60, and 70 by various types of transitory computer-readable media. Examples of transitory computer-readable media include electrical signals, optical signals, and electromagnetic waves. The temporary computer-readable medium can supply the program to the arrangement control apparatus 10, 50, 60, or 70 via a wired communication path such as an electric wire or an optical fiber, or a wireless communication path.

Although the invention of the present application has been described above with reference to the example embodiments, the invention of the present application is not limited to the above. Various modifications that can be understood by those skilled in the art can be made to the configuration and details of the invention of the present application within the scope of the invention.

Some or all of the above-described example embodiments can be described as in the following supplementary notes, but are not limited to the following supplementary notes.

### Supplementary Note 1

An arrangement control system including:
an acquisition means for acquiring upper limit information indicating an arrangement space in a candidate arrangement location of a target object, target object information including size information indicating a size of the target object, and information regarding an occupied space of an arrangement object arranged in the candidate arrangement location detected by a sensing means; and
a determination means for outputting a determination result obtained by determining whether the target object can be arranged in the candidate arrangement location based on the upper limit information, the target object information, and the information regarding the occupied space of the arrangement object.

### Supplementary Note 2

The arrangement control system according to supplementary note 1, further including: a notification means for notifying a signal including map information indicating whether the target object can be arranged with respect to the candidate arrangement location as information indicating the determination result.

### Supplementary Note 3

The arrangement control system according to supplementary note 1 or 2, in which the target object information includes an arrangement condition that is an additional condition required for the candidate arrangement location in which it is determined that the target object can be arranged.

### Supplementary Note 4

The arrangement control system according to any one of supplementary notes 1 to 3, in which
the acquisition means acquires the upper limit information in each of a plurality of the candidate arrangement locations in an area where a transport apparatus can transport the target object and the information regarding the occupied space of the arrangement object arranged in each of the candidate arrangement locations, and
the determination means determines, for each of the candidate arrangement locations, whether the target object can be arranged in each of the candidate arrangement locations based on the upper limit information, the target object information, and the information regarding the occupied space of the arrangement object.

### Supplementary Note 5

The arrangement control system according to supplementary note 4, in which
the target object information includes an arrangement condition, and
the arrangement control system includes a selection means for selecting a candidate arrangement location that satisfies the arrangement condition from among one or more candidate arrangement locations in which it is determined that the target object can be arranged.

### Supplementary Note 6

The arrangement control system according to any one of supplementary notes 1 to 5, in which
the acquisition means acquires information regarding a pose of an arrangement object arranged in the candidate arrangement location, and
the determination means determines whether the target object can be arranged on the arrangement object based on the upper limit information, the target object information, the information regarding the occupied space of the arrangement object, and the information regarding the pose of the arrangement object.

### Supplementary Note 7

An arrangement control apparatus including:
an acquisition means for acquiring upper limit information indicating an arrangement space in a candidate arrangement location of a target object, target object information including size information indicating a size of the target object, and information regarding an occupied space of an arrangement object arranged in the candidate arrangement location detected by a sensing means; and
a determination means for outputting a determination result obtained by determining whether the target object can be arranged in the candidate arrangement location based on the upper limit information, the target object information, and the information regarding the occupied space of the arrangement object.

### Supplementary Note 8

The arrangement control apparatus according to supplementary note 7, further including: a notification means for notifying a signal including map information indicating whether the target object can be arranged with respect to the candidate arrangement location as information indicating the determination result.

### Supplementary Note 9

The arrangement control apparatus according to supplementary note 7 or 8, in which the target object information includes an arrangement condition that is an additional condition required for the candidate arrangement location in which it is determined that the target object can be arranged.

### Supplementary Note 10

The arrangement control apparatus according to any one of supplementary notes 7 to 9, in which
the acquisition means acquires the upper limit information in each of a plurality of the candidate arrangement locations in an area where a transport apparatus can transport the target object and the information regarding the occupied space of the arrangement object arranged in each of the candidate arrangement locations, and
the determination means determines, for each of the candidate arrangement locations, whether the target object can be arranged in each of the candidate arrangement locations based on the upper limit information, the target object information, and the information regarding the occupied space of the arrangement object.

### Supplementary Note 11

The arrangement control apparatus according to supplementary note 10, in which
the target object information includes an arrangement condition, and
the arrangement control apparatus includes a selection means for selecting a candidate arrangement location satisfying the arrangement condition from among one or more candidate arrangement locations in which it is determined that the target object can be arranged.

Supplementary Note 12

The arrangement control apparatus according to any one of supplementary notes 7 to 11, in which
the acquisition means acquires information regarding a pose of an arrangement object arranged in the candidate arrangement location, and
the determination means determines whether the target object can be arranged on the arrangement object based on the upper limit information, the target object information, the information regarding the occupied space of the arrangement object, and the information regarding the pose of the arrangement object.

### Supplementary Note 13

An arrangement control method including:
acquiring upper limit information indicating an arrangement space in a candidate arrangement location of a target object, target object information including size information indicating a size of the target object, and information regarding an occupied space of an arrangement object arranged in the candidate arrangement location detected by a sensing means; and
outputting a determination result obtained by determining whether the target object can be arranged in the candidate arrangement location based on the upper limit information, the target object information, and the information regarding the occupied space of the arrangement object.

### Supplementary Note 14

The arrangement control method according to supplementary note 13, further including: notifying a signal including map information indicating whether the target object can be arranged with respect to the candidate arrangement location as information indicating the determination result.

### Supplementary Note 15

The arrangement control method according to supplementary note 13 or 14, in which the target object information includes an arrangement condition that is an additional condition required for the candidate arrangement location in which it is determined that the target object can be arranged.

### Supplementary Note 16

The arrangement control method according to any one of supplementary notes 13 to 15, in which
the acquiring includes acquiring the upper limit information in each of a plurality of the candidate arrangement locations in an area where a transport apparatus can transport the target object and the information regarding the occupied space of the arrangement object arranged in each of the candidate arrangement locations, and
the determining includes determining, for each of the candidate arrangement locations, whether the target object can be arranged in each of the candidate arrangement locations based on the upper limit information, the target object information, and the information regarding the occupied space of the arrangement object.

### Supplementary Note 17

The arrangement control method according to supplementary note 16, in which
the target object information includes an arrangement condition, and
the arrangement control method includes selecting a candidate arrangement location that satisfies the arrangement condition from among one or more candidate arrangement locations in which it is determined that the target object can be arranged.

### Supplementary Note 18

The arrangement control method according to any one of supplementary notes 13 to 17, in which
the acquiring includes acquiring information regarding a pose of an arrangement object arranged in the candidate arrangement location, and
the determining includes determining whether the target object can be arranged on the arrangement object based on the upper limit information, the target object information, the information regarding the occupied space of the arrangement object, and the information regarding the pose of the arrangement object.

### Supplementary Note 19

A program for causing a computer to execute processing including:
acquiring upper limit information indicating an arrangement space in a candidate arrangement location of a target object, target object information including size information indicating a size of the target object, and information regarding an occupied space of an arrangement object arranged in the candidate arrangement location detected by a sensing means; and
outputting a determination result obtained by determining whether the target object can be arranged in the candidate arrangement location based on the upper limit information, the target object information, and the information regarding the occupied space of the arrangement object.

### REFERENCE SIGNS LIST

1 ARRANGEMENT CONTROL SYSTEM
2 ARRANGEMENT CONTROL SYSTEM
3 ARRANGEMENT CONTROL SYSTEM
4 ARRANGEMENT CONTROL SYSTEM
10 ARRANGEMENT CONTROL APPARATUS
11 ACQUISITION UNIT
12 DETERMINATION UNIT
20 SENSOR
30 MANAGEMENT APPARATUS
40 TRANSPORT APPARATUS
50 ARRANGEMENT CONTROL APPARATUS
51 SELECTION UNIT
60 ARRANGEMENT CONTROL APPARATUS
61 NOTIFICATION UNIT
70 ARRANGEMENT CONTROL APPARATUS
71 ACQUISITION UNIT
72 DETERMINATION UNIT

What is claimed is:

1. An arrangement control system comprising:
at least one memory storing instructions, and
at least one processor configured to execute the instructions to;
acquire upper limit information indicating an arrangement space in a candidate arrangement location of a target object, target object information including size information indicating a size of the target object, and information regarding an occupied space of an arrangement object arranged in the candidate arrangement location detected by a sensing means; and
output a determination result obtained by determining whether the target object can be arranged in the candidate arrangement location based on the upper limit information, the target object information, and the information regarding the occupied space of the arrangement object.

2. The arrangement control system according to claim 1, wherein the at least one processor is configured to notify a signal including map information indicating whether the target object can be arranged with respect to the candidate arrangement location as information indicating the determination result.

3. The arrangement control system according to claim 1, wherein the target object information includes an arrangement condition that is an additional condition required for the candidate arrangement location in which it is determined that the target object can be arranged.

4. The arrangement control system according to claim 1, wherein the at least one processor is configured to:
acquire the upper limit information in each of a plurality of the candidate arrangement locations in an area where a transport apparatus can transport the target object and the information regarding the occupied space of the arrangement object arranged in each of the candidate arrangement locations, and
determine, for each of the candidate arrangement locations, whether the target object can be arranged in each of the candidate arrangement locations based on the upper limit information, the target object information, and the information regarding the occupied space of the arrangement object.

5. The arrangement control system according to claim 4, wherein
the target object information includes an arrangement condition, and
the at least one processor is configured to select a candidate arrangement location that satisfies the arrangement condition from among one or more candidate arrangement locations in which it is determined that the target object can be arranged.

6. The arrangement control system according to claim 1, wherein the at least one processor is configured to:
acquire information regarding a pose of an arrangement object arranged in the candidate arrangement location, and
determine whether the target object can be arranged on the arrangement object based on the upper limit information, the target object information, the information regarding the occupied space of the arrangement object, and the information regarding the pose of the arrangement object.

7. An arrangement control apparatus comprising:
at least one memory storing instructions, and
at least one processor configured to execute the instructions to;
acquire upper limit information indicating an arrangement space in a candidate arrangement location of a target object, target object information including size information indicating a size of the target object, and information regarding an occupied space of an arrangement object arranged in the candidate arrangement location detected by a sensing means; and
output a determination result obtained by determining whether the target object can be arranged in the candidate arrangement location based on the upper limit information, the target object information, and the information regarding the occupied space of the arrangement object.

8. The arrangement control apparatus according to claim 7, wherein the at least one processor is configured to notify a signal including map information indicating whether the target object can be arranged with respect to the candidate arrangement location as information indicating the determination result.

9. The arrangement control apparatus according to claim 7, wherein the target object information includes an arrangement condition that is an additional condition required for the candidate arrangement location in which it is determined that the target object can be arranged.

10. The arrangement control apparatus according to claim 7, wherein the at least one processor is configured to:
acquire the upper limit information in each of a plurality of the candidate arrangement locations in an area where a transport apparatus can transport the target object and the information regarding the occupied space of the arrangement object arranged in each of the candidate arrangement locations, and
determine, for each of the candidate arrangement locations, whether the target object can be arranged in each of the candidate arrangement locations based on the upper limit information, the target object information, and the information regarding the occupied space of the arrangement object.

11. The arrangement control apparatus according to claim 10, wherein
the target object information includes an arrangement condition, and
the at least one processor is configured to select a candidate arrangement location satisfying the arrangement condition from among one or more candidate arrangement locations in which it is determined that the target object can be arranged.

12. The arrangement control apparatus according to claim 7, wherein the at least one processor is configured to:
acquire information regarding a pose of an arrangement object arranged in the candidate arrangement location, and
determine whether the target object can be arranged on the arrangement object based on the upper limit information, the target object information, the information regarding the occupied space of the arrangement object, and the information regarding the pose of the arrangement object.

13. An arrangement control method comprising:
acquiring upper limit information indicating an arrangement space in a candidate arrangement location of a target object, target object information including size information indicating a size of the target object, and information regarding an occupied space of an arrangement object arranged in the candidate arrangement location detected by a sensing means; and
outputting a determination result obtained by determining whether the target object can be arranged in the candidate arrangement location based on the upper limit information, the target object information, and the information regarding the occupied space of the arrangement object.

14. The arrangement control method according to claim 13, further comprising: notifying a signal including map information indicating whether the target object can be arranged with respect to the candidate arrangement location as information indicating the determination result.

15. The arrangement control method according to claim 13, wherein the target object information includes an arrangement condition that is an additional condition required for the candidate arrangement location in which it is determined that the target object can be arranged.

16. The arrangement control method according to claim 13, wherein
the acquiring includes acquiring the upper limit information in each of a plurality of the candidate arrangement locations in an area where a transport apparatus can transport the target object and the information regarding the occupied space of the arrangement object arranged in each of the candidate arrangement locations, and
the determining includes determining, for each of the candidate arrangement locations, whether the target object can be arranged in each of the candidate arrangement locations based on the upper limit information, the target object information, and the information regarding the occupied space of the arrangement object.

17. The arrangement control method according to claim 16, wherein
the target object information includes an arrangement condition, and
the arrangement control method includes selecting a candidate arrangement location that satisfies the arrangement condition from among one or more candidate arrangement locations in which it is determined that the target object can be arranged.

18. The arrangement control method according to claim 13, wherein
the acquiring includes acquiring information regarding a pose of an arrangement object arranged in the candidate arrangement location, and
the determining includes determining whether the target object can be arranged on the arrangement object based on the upper limit information, the target object information, the information regarding the occupied space of the arrangement object, and the information regarding the pose of the arrangement object.
